(19) United States
(12) Patent Application Publication
(10) Pub. No.: US 2006/0144536 A1
(43) Pub. Date: Jul. 6, 2006

(54) Soft and durable tissues made with thermoplastic polymer complexes

(76) Inventors: Deborah Joy Nickel, Appleton, WI (US); Troy Michael Runge, Appleton, WI (US); Gil Bernard Didier Garnier, Neenah, WI (US); Thomas Joseph Dyer, Neenah, WI (US)

Correspondence Address: KIMBERLY-CLARK WORLDWIDE, INC., 401 NORTH LAKE STREET, NEENAH, WI, 54956, US

(21) Appl. No.: 11/027,065

(22) Filed: Dec. 30, 2004

(51) Int. Cl. B31F 1/12; D21H 17/36

(52) U.S. Cl. 162/111; 162/158; 162/169; 162/168.1

(57) ABSTRACT

A thermoplastic complex comprises an emulsified hydrophobic thermoplastic polymer and a complexing agent. The thermoplastic complex can formed by pre-mixing an emulsified hydrophobic thermoplastic polymer with a complexing agent to form a paste-like complex. The thermoplastic complex can then be dispersed in a water-fiber suspension in the wet-end section of a tissuemaking process. The fibers in the water-fiber suspension retain a substantial amount of the complex. A fibrous web can be formed comprising the treated fibers, which can then be converted into a tissue product that exhibits improved softness with minimized slough.

### BACKGROUND

The invention generally concerns tissue products and properties thereof. More particularly, in the manufacture of personal care tissue products, such as facial tissues, bath tissues, napkins, wipes, and tissue towels, it is often desired to optimize various aesthetic and performance related properties. For example, personal care products should generally exhibit a soft feel, low slough, good bulk, and sufficient strength to perform the desired functions.

Unfortunately, when conventional methods are used to increase one of these properties, other such properties can be adversely affected. For instance, softness is an important aesthetic property of many personal care tissue products, so it is desirable in the art to develop products which exhibit improved softness. One conventional method for improving softness in such products is to apply a chemical debonder to the fiber-water suspension in the wet-end section of a tissue machine. Another conventional method is to spray such a chemical debonder directly onto the fibrous web in the forming section of a tissue machine. In either case, the chemical debonder interrupts the bonding which would normally take place between the fibers, which reduces the overall strength of the fibrous web. This reduction in strength corresponds directly to an increase in softness.

However, this same reduction in strength also leads to an increase in slough, which is generally undesirable for personal care products. For example, during processing and/or use, the loosely bound (i.e., debonded) fibers can be freed from the tissue product, thereby creating airborne fibers and fiber fragments. Moreover, zones of fibers that are poorly bound to each other but not to adjacent zones of fibers may be created which can break away from the tissue surface and then can deposit onto other surfaces, such as human skin or clothing. Therefore, there is a desire for a tissue product which exhibits improved softness while minimizing the level of slough.

### SUMMARY

The invention concerns a tissue product and properties thereof. In general, the invention concerns the use of a thermoplastic polymer complex to produce a soft tissue product which exhibits minimized slough. More particularly, a thermoplastic complex is formed by pre-mixing an emulsified hydrophobic thermoplastic polymer with a complexing agent to form a paste-like complex, and then re-disbursing the complex in a water-fiber suspension in the wet-end section of a tissuemaking process. The fibers in the water-fiber suspension can retain a substantial amount of the complex (e.g., the complex can adsorb to the surface of the fibers in the water-fiber suspension), thus making the treatment process highly efficient.

The resulting tissue product can exhibit a desired degree of tensile reduction, resulting in a corresponding increase of softness. Additionally, the tissue product can also exhibit a minimized level of slough. Such products can comprise a single layer or multiple layers of treated and/or untreated fibers.

Numerous other features and advantages of the present invention will appear from the following description. In the description, reference is made to the accompanying drawings which help illustrate exemplary embodiments of the invention. Such embodiments do not represent the full scope of the invention. Reference should therefore be made to the claims herein for interpreting the full scope of the invention.

### BRIEF DESCRIPTION OF THE DRAWINGS

The foregoing and other features, aspects and advantages of the present invention will become better understood with regard to the following description, appended claims and accompanying drawings where:

FIG. 1 illustrates a block flow diagram of an exemplary wet-end section of a tissuemaking process;

FIG. 2 illustrates one embodiment of a tissue machine that can be used to form a fibrous web comprising thermoplastic complex treated fibers made in accordance with the present invention;

FIG. 3 illustrates one embodiment of a headbox that can be used in accordance with the present invention;

FIG. 4a illustrates an apparatus for testing slough; and

FIG. 4b is a perspective view of the abrasive spindle of FIG. 4a.

Repeated use of reference characters in the present specification and drawings is intended to represent the same or analogous features or elements of the present invention.

### DEFINITIONS

It should be noted that, when employed in the present disclosure, the terms “comprises,” “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The terms “additive” and “chemical additive” refer to a single treatment compound or a mixture of treatment compounds.

The term “hydrophobic” refers to a material having a contact angle of water in air of at least 90 degrees. In contrast, as used herein, the term “hydrophilic” refers to a material having a contact angle of water in air of less than 90 degrees. For the purposes of this application, contact angle measurements are determined as set forth in Robert J. Good and Robert J. Stromberg, Ed:, in “Surface and Colloid Science—Experimental Methods,” Vol. II, (Plenum Press, 1979), herein incorporated by reference in a manner consistent with the present disclosure.

The term “slough” refers to the loss of tissue particles from the surface of tissue due to surface abrasion. Slough tends to increase when conventional softening techniques, such as the use of chemical debonders, are utilized in the wet-end section of a tissue machine. In general, slough is an undesirable property for tissue products. For example, many consumers react negatively to tissue that exhibits a high level of slough. Therefore, it is a desire to provide a tissue product that exhibits a minimal amount of slough.

The term “tissue product” is used herein to broadly include tissue such as bath tissue, facial tissue, napkins, wipers, and towels, along with other tissue structures including absorbent pads, intake webs in absorbent articles such as diapers, bed pads, wet wipes, meat and poultry pads, feminine care pads, and the like made in accordance with any conventional process for the production of such products. The term “tissue” as used herein includes any fibrous web containing cellulosic fibers alone or in combination with other fibers, natural or synthetic. A tissue product can be layered or unlayered, creped or uncreped, and can comprise a single ply or multiple plies. In addition, the tissue product can contain reinforcing fibers for integrity and strength.

The term “water” refers to water or a solution containing water and other treatment additives desired in the tissuemaking process.

These terms may be defined with additional language in the remaining portions of the specification.

### DETAILED DESCRIPTION

The invention concerns a tissue product and properties thereof. In general, the invention concerns the use of a thermoplastic polymer complex to produce a soft tissue product that can have minimized slough. More particularly, a thermoplastic complex is formed by pre-mixing an emulsified hydrophobic thermoplastic polymer with a complexing agent to form a paste-like complex, and then re-disbursing the complex in a water-fiber suspension in the wet-end section of a tissuemaking process. The fibers in the water-fiber suspension can retain a substantial amount of the complex (e.g., the complex can adsorb to the surface of the fibers in the water-fiber suspension), thus making the treatment process highly efficient.

Tissue products can generally be formed in accordance with the present invention from at least one fibrous web. For example, in one aspect, the tissue product can contain a single-layered fibrous web formed from a blend of treated and untreated fibers. In another aspect, the tissue product can contain a multi-layered (i.e., stratified) fibrous web wherein at least one layer comprises at least treated fibers, and at least one layer comprises at least untreated fibers. Furthermore, the tissue product itself can be constructed from a single fibrous web or from multiple fibrous webs. In one particular aspect, at least one fibrous web in the tissue product comprises treated fibers according to the present invention.

In general, the basis weight of a fibrous web of the present invention is less than about 200 grams per square meter (gsm), such as between about 5 gsm and about 120 gsm or between about 20 gsm to about 100 gsm. Fibers that are suitable for tissue products of the present invention include cellulosic fibers such as hardwood fibers, softwood fibers, recycled fibers, and the like, as well as synthetic fibers. Such fibers can be formed by a variety of pulping processes, including Kraft, sulfite, mechanical, thermomechanical, and chemithermomechanical pulping processes, and the like. In one example, the tissue product includes a fibrous web having at least one layer formed primarily from Eucalyptus Kraft fibers treated in accordance with the present invention.

Hardwood fibers such as Eucalyptus, maple, birch, and aspen typically have an average fiber length of less than about 1.5 mm and exhibit relatively large diameters (as compared to softwood fibers). As such, hardwood fibers may be more useful for enhancing the softness of a fibrous web than softwood fibers. Therefore, it may be desirable to provide at least one outer surface of a tissue product which comprises substantially hardwood fibers. However, when conventional methods are utilized to enhance softness, such as through the addition of a chemical debonder in the wet-end section of a tissue machine, fibrous webs containing hardwood fibers tend to result in substantially higher levels of slough.

In contrast, softwood fibers such as northern softwood, southern softwood, redwood, cedar, hemlock, pine, and spruce typically have an average fiber length of about 1.5 mm to about 3 mm with relatively small diameters (as compared to hardwood). As such, softwood fibers may be more useful for enhancing the strength of a fibrous web than hardwood fibers. However, softwood fibers can substantially reduce the softness of a fibrous web. In addition, like hardwood fibers, softwood fibers can also result in increased levels of slough when conventional methods are used to enhance softness. Therefore, softwood fibers are typically blended with hardwood fibers, or may be used as an inner layer in a multi-layered fibrous web.

If desired, secondary fibers obtained from recycled materials may also be utilized in a tissue product in accordance with the present invention. Such secondary fibers can be obtained from sources including old newsprint, reclaimed tissueboard, envelopes, and mixed office waste. Additionally, other natural fibers can be utilized, such as abaca, sabai grass, milkweed floss, pineapple leaf, and the like. Furthermore, in some instances, synthetic fibers can also be utilized, such as rayon fibers, ethylene vinyl alcohol copolymer fibers, polyolefin fibers, polyesters, and the like.

Suitable cellulosic fibers for the present invention can include, for example, ARACRUZ ECF, a Eucalyptus hardwood Kraft pulp available from Aracruz, a business having offices located in Rio de Janeiro, RJ, Brazil; TERRACE BAY LONGLAC-19, a northern softwood Kraft pulp available from Neenah Tissue Inc., a business having offices located in Alpharetta, Ga., U.S.A.; NB 416, a bleached southern softwood Kraft pulp, available from Weyerhaeuser Company., a business having offices located in Federal Way, Wash., U.S.A.; CR 54, a bleached southern softwood Kraft pulp, available from Bowater Inc., a business having offices located in Greenville, S.C., U.S.A.; SULPHATATE HJ, a chemically modified hardwood pulp, available from Rayonier Inc., a business having offices located in Jesup, Ga., U.S.A.; NF 405, a chemically treated bleached southern softwood Kraft pulp, available from Weyerhaeuser Co.; and CR 1654, a mixed bleached southern softwood and hardwood Kraft pulp, also available from Bowater Inc.

As referenced above, a tissue product made in accordance with the present invention can be formed from one or more fibrous webs, each of which can be single-layered or multi-layered. For instance, in one aspect, the tissue product can comprise a single-layered tissue web that is formed from a blend of fibers. For example, in some instances, hardwood fibers and softwood fibers can be homogeneously blended to form the single-layered tissue web. In another aspect, the tissue product can contain a multi-layered tissue web that is formed from a stratified pulp furnish having various principal layers. In one particular aspect, the fibrous web can comprise three layers wherein at least one of the outer layers includes treated hardwood fibers, while at least the inner layer includes untreated northern softwood Kraft fibers. In another aspect, the fibrous web can comprise two layers wherein one layer comprises pre-treated hardwood Kraft fibers, while the remaining outer layer comprises a blend of untreated northern softwood Kraft fibers and untreated synthetic fibers. In still another aspect, the fibrous web can comprise three layers wherein at least one of the outer layers includes a blend of treated hardwood fibers and untreated softwood fibers, while the inner layer comprises untreated recycled fibers. It should be understood that a multi-layered tissue web can include any number of layers and can be made from various types of fibers.

In accordance with the present invention, various properties of a tissue product such as described above, can be optimized. For instance, softness, slough level, strength (e.g., tensile index), bulk and the like, are some examples of properties which may be optimized in accordance with the present invention. However, it should be understood that not every property mentioned above needs to be optimized in every instance. For example, in certain applications, it may be desired to form a tissue product that has optimized softness without regard to strength.

For purposes of the invention, the process of treating fibers with a thermoplastic polymer complex can be accomplished by first mixing an emulsified hydrophobic thermoplastic polymer with a cationic complexing agent to form a paste-like polymer complex. Once formed, this thermoplastic complex can then be introduced into the water-fiber suspension in a desired location in the pulp stream of a tissuemaking process where the complex disperses. The dispersed thermoplastic complex then contacts and bonds to at least a portion of the anionic fiber surfaces to form treated fibers in accordance with the invention. The treated fibers then proceed to the forming section of a tissue machine, where they can be formed into a fibrous web, dried, and then converted into a desired tissue product. Optionally, the treated fibers may be mixed with untreated fibers prior to formation of the web. The result is a tissue product which exhibits an increased level of softness while minimizing the level of slough. Without being bound by a particular theory, it is believed that treating fibers with a thermoplastic polymer complex in accordance with the invention results in fibers that maintain at least some areas of high bonding strength while decreasing the overall bonded area between the fibers. In particular, it is believed that the overall bonded area is decreased due to the mere presence of the complex acting as a barrier and preventing potential fiber bonding to form by hydrogen bonds, while at the same time acting as an adhesive between fibers and increasing bond strength and mobility through fiber-polymer complex mechanical bonds.

Additionally, again without being held to a particular theory, it is believed that the polymer complex created for treating fibers in accordance with the present invention results in fibers that are more resilient to compression when wet. This, in turn, can result in a higher caliper and bulk of a resulting tissue web since such treated fibers can resist compression from a pressure roll on a tissue machine.

Suitable emulsified hydrophobic thermoplastic polymers, when mixed with a suitable complexing agent, should form a thermoplastic complex which has the ability to substantially disperse when exposed to a water-fiber suspension of a tissuemaking process. In some aspects, the thermoplastic polymer complex can decrease the hydrophilicity (contact angle) of the fibers and/or prevent the fibers from swelling. In other aspects, the thermoplastic complex can decrease the overall bonding potential of the fibers without decreasing the surface fiber tension of the fiber-water suspension. In still other aspects, the thermoplastic complex can decrease the strength of a tissue web formed from the treated fibers by at least about 30%, such as at least about 50%, as compared to a similar web consisting of untreated fibers.

Emulsified hydrophobic thermoplastic polymers can have a solids content of at least about 20% by weight, such as about 40% by weight, or between about 40% and 80% by weight. Suitable emulsified hydrophobic thermoplastic polymers include polyolefin and copolymers thereof (including polyethylene, polypropylene and their copolymers), styrene butadiene latex and copolymers thereof, polyvinyl acetate copolymers, vinyl acetate acrylic copolymers, ethylene-vinyl chloride copolymers, acrylic polymers, nitrile polymers, and combinations thereof. Such polymers are suitably nonionic or anionic, have a glass transition temperature (T_{g}) of less than 40° C., and have a contact angle greater than 90 degrees. In addition, when in their un-complexed state, such emulsified hydrophobic thermoplastic polymers often do not substantially retain onto fibers when added to the wet-end section of a tissuemaking process. However, the same such polymers, when mixed with a suitable complexing agent, forms a complex which is water dispersable and does substantially retain onto fibers when added to the wet-end section of a tissuemaking process.

In general, polyolefin emulsions are typically utilized as additives for printing ink, heat sealants, and primer/adhesives; additives for lubricants, rubber and resins; lubricants in clay coatings for fine paper applications, and additives in floor polishes to improve slip resistance. Likewise, in general, latex emulsions are typically used in coatings for fine paper, publication paper and coated paperboard used in packaging, such as for improved printing performance. However, when these emulsions are used in accordance with the present invention, they result in a tissue product which exhibits improved softness while minimizing slough. In one particular feature, the emulsified hydrophobic thermoplastic polymer is LATRIX 6300, available from Nalco Company, a business having offices in Naperville, Ill., U.S.A. Other emulsified hydrophobic thermoplastic polymers could include EPOLENE E20 available from Eastman Chemical Company, a business having offices located in Rochester, N.Y., U.S.A., as well as dispersions made (using techniques known in the art) with AMPLIFY EA 102 or PRIMACOR 1430, both available from Dow Chemical Company, a business having offices located in Freeport, Tex., U.S.A. It is within the scope of the invention to utilize more than one emulsion to form the thermoplastic complex.

Suitable complexing agents include cationic surfactants, cationic polyelectrolytes, and cationic mono and multivalent salts. Examples of cationic surfactants include quaternary amine imidazolines, quaternary ammonium alkyl halides, like cetyl trimethyl ammonium chloride and cetyl trimethyl ammonium bromide. Examples of cationic polyelectrolytes include glyoxylated polyacrylamides, polyamide-polyamine-epichlorohydrins, polyacrylamide copolymers, polyethylenimine, polyvinylpyridine, poly (diallyldimethylammonium halide) coplymers, (Poly DADMAC), and poly(amines), poly(amides) and their copolymers. Examples of cationic mono and multivalent salts include sodium chloride, calcium chloride, aluminium chloride, and alum. In one particular feature, the complexing agent is a commercially available cationic surfactant and debonding agent under the trade name PROSOFT TQ-1003, available from Hercules Inc., a business having offices located Wilmington, Del., U.S.A. In another particular feature, the complexing agent is a commercially available cationic polyelectrolyte under the trade name PAREZ 631 NC, available from Cytec Industries Inc., a business having offices located in West Paterson, N.J., U.S.A. In still another example, the complexing agent is a commercially available cationic polyelectrolyte under the trade name KYMENE 6500, available from Hercules Inc.

The amount of complexing agent utilized to form the complex of the present invention is dependent upon the emulsified thermoplastic hydrophobic polymer selected. In general, the ratio by weight of polymer to complexing agent can be in the range of about 1:5 up to at least about 20:1 to form a suitable thermoplastic complex. For instance, in one particular example, a 2:1 ratio of LATRIX 6300 and PROSOFT TQ-1003 was utilized to form a thermoplastic complex which resulted in an improved tissue product. In another particular example, a 1:1 ratio of LATRIX 6300 and PROSOFT TQ-1003 was utilized to form a thermoplastic complex which resulted in an improved tissue product. Still other examples can be seen in the Tables below.

As referenced above, the thermoplastic complex made in accordance with the present invention comprises an emulsified hydrophobic thermoplastic polymer and a complexing agent. In one particular aspect, the thermoplastic complex consists essentially of the emulsified hydrophobic thermoplastic polymer and the complexing agent. The thermoplastic complex can be utilized in varying dosages. Such dosages are dependent upon the constituents utilized to form the thermoplastic complex. In general, a suitable addition rate can be less than about 100 kilograms thermoplastic complex per oven dry metric ton of fiber (kg/ODMT), such as about 1 to about 50 kg/ODMT of fiber or about 1 to about 20 kg/ODMT of fiber. In one particular example, a thermoplastic complex comprising a mixture having a mass ratio of 1:1 of LATRIX 6300 having a solids content of about 50% by weight and PROSOFT TQ-1003 having a solids content of about 80% by weight was added to ARACRUZ ECF Eucalyptus hardwood Kraft fibers at a dosage rate of 10 kg/ODMT to obtain an improved tissue product. In another particular example, the same complex was added at a dosage rate of 1 kg/ODMT of fiber to obtain an improved tissue product.

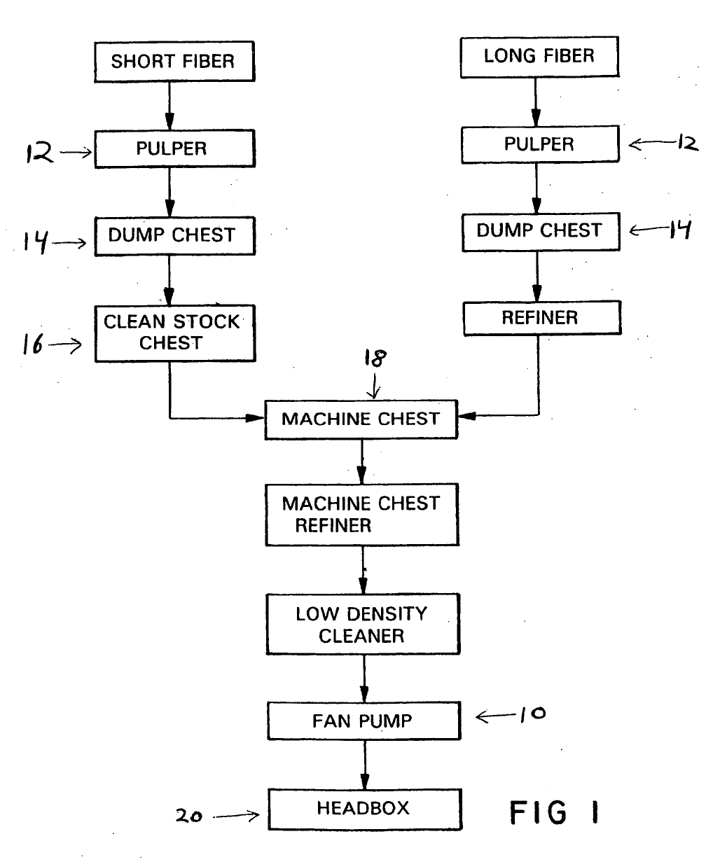

As mentioned above, the thermoplastic complex of the present invention can be added to a water-fiber suspension of a tissuemaking process. In some aspects, the water-fiber suspension has a consistency of less than about 20% fiber by weight, such as between about 0.1% and about 10% fiber by weight to obtain effective dispersion of the complex. Suitable addition points can include areas located in the wet-end section of the fibermaking process. By way of example only, FIG. 1 presents a block flow diagram illustrating a typical wet-end section. It is suitable to add the thermoplastic complex at any point within the illustrated process, prior to the headbox of a tissue machine. In some aspects, the thermoplastic complex could alternatively or additionally be added during an off-line process, such as in the wet-end section of a wet-lap or dry-lap manufacturing process. Such treated fiber can then be re-dispersed in a papermaking pulping system as in FIG. 1 with the treated fibers retaining the thermoplastic complex.

An exemplary tissue making process which could be utilized for the present invention is described below. Initially, one or more fiber furnishes are provided. For instance, in one aspect, two fiber furnishes can be utilized. Although other fibers may be utilized, at least one of the fiber furnishes should comprise fibers treated with the thermoplastic complex. Moreover, by way of example, a second fiber furnish can contain treated or untreated softwood fibers. In still other aspects, by way of example, the second furnish or a third fiber furnish can contain treated or untreated hardwood fibers, softwood fibers, recycled fibers, synthetic fibers, or combinations thereof.

As seen in FIG. 1, the above exemplary fiber furnishes can be separately pulped in a pulper 12 to disperse the fibers into individual fibers. The pulpers can run continuously or in a batch format to supply fibers to the tissuemaking machine. Once the fibers are dispersed, the furnishes can then, in some embodiments, be pumped to a dump chest 14 and diluted to a consistency of about 3% to about 4% by weight. Thereafter, the fiber furnish can be transferred directly to a clean stock chest 16 where it may be diluted to a consistency of about 2% to about 3% by weight. The furnish(es) can then be sent to and/or combined in a machine chest 18. If desired, additional chemical additives can also be added to the dump chest 14, the clean stock chest 16, and/or the machine chest 18 to improve various properties of the finished product. The furnish can further be diluted, if desired, to a consistency of about 0.1% by weight at the fan pump 10 prior to entering the headbox 20 of a tissue machine.

A tissue product made in accordance with the present invention can generally be formed according to a variety of web forming processes and tissuemaking machines known in the art. In fact, any process capable of making a tissue web can be utilized in the present invention. For example, a tissuemaking process of the present invention can utilize wet-pressing, creping, through-air-drying, creped through-air-drying, uncreped through-air-drying, single recreping, and double recreping. Also, molding, calendering, embossing, as well as other steps in processing the tissue web may also be utilized. By way of illustration, various suitable tissuemaking processes are disclosed in U.S. Pat. No. 5,667,636 to Engel et al.; U.S. Pat. No. 5,607,551 to Farrington, Jr. et al.; U.S. Pat. No. 5,672,248 to Wendt et al.; and, U.S. Pat. No. 5,494,554 to Edwards et al., all of which are herein incorporated by reference in a manner that is consistent with the present disclosure.

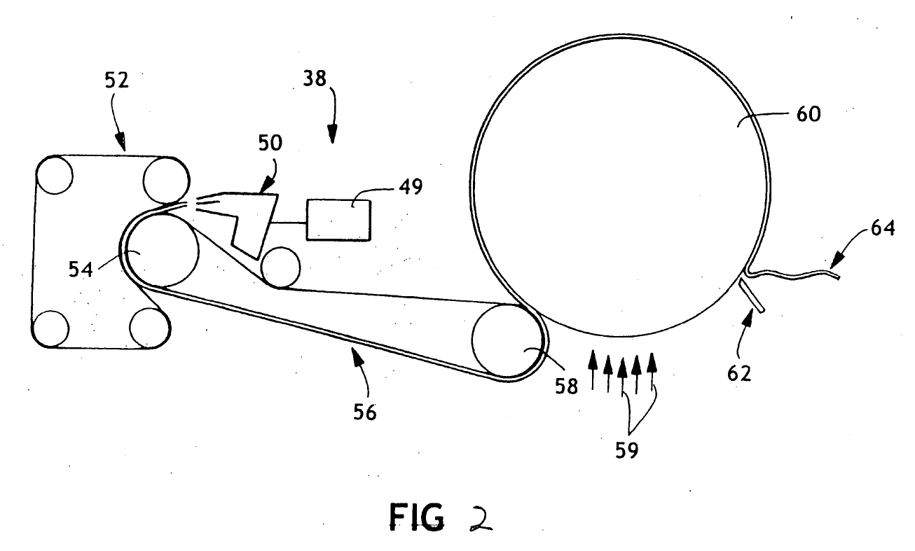

With reference to FIG. 2, an exemplary fibrous web forming process 38 (i.e., tissuemaking machine) is described. In this example, a tissue web 64 is formed using a 2-layer headbox 50 between a forming fabric 52 and a conventional wet press tissuemaking (or carrier) felt 56 which wraps at least partially about a forming roll 54 and a press roll 58. The tissue web 64 is then transferred from the tissuemaking felt 56 to the Yankee dryer 60 by applying a vacuum press roll 58. An adhesive mixture is optionally sprayed using a spray boom 59 onto the surface of the Yankee dryer 60 just before the application of the tissue web to the Yankee dryer 60 by the press roll 58. In some aspects, certain additives can be applied to the tissue web as the web traverses over the dryer 60. A natural gas heated hood (not shown) may partially surround the Yankee dryer 60, assisting in drying the tissue web 64. The tissue web 64 is then removed from the Yankee dryer by a creping doctor blade 62.

The single tissue web 64 may optionally be calendered (not shown), and is then wound onto a hard roll (not shown). The substrate can then be converted using various means known in the art to produce a tissue product which exhibits enhanced softness and minimized slough due to the retention of the thermoplastic complex of the present invention onto the fibers.

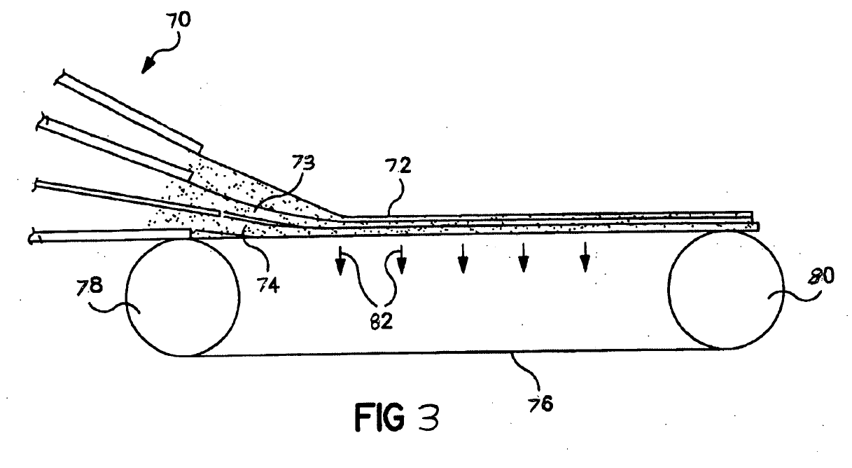

Although the exemplary embodiment discussed above relates to a multi-layered tissue web having two layers, it should be understood that the tissue web can contain any number of layers greater than or equal to one. For example, FIG. 3 illustrates a particular aspect wherein a tissue machine comprises a 3-layer headbox. As shown, an endless traveling forming fabric 76, suitably supported and driven by rolls 78 and 80, receives the layered tissue making stock issuing from the headbox 70. Once retained on the fabric 76, the fiber suspension passes water through the fabric as shown by the arrows 82. In one aspect, at least one of the outer layers 72,74 can contain thermoplastic complex treated fibers and at least the inner-layer 73 can contain strength enhancing fibers. Water removal can then be achieved as described above.

In addition, it should also be understood that the layers of the multi-layered tissue web can also contain more than one type of fiber. For example, in some aspects, one of the layers can contain a blend of thermoplastic complex treated hardwood fibers and untreated hardwood fibers, a blend of treated hardwood fibers and untreated softwood fibers, a blend of untreated hardwood fibers and treated softwood fibers, a blend of treated hardwood fibers and recycled fibers, a blend of treated hardwood fibers and synthetic fiber, and the like.

It should be further understood that a tissue product of the present invention can comprise single or multiple fibrous webs. At least one of these webs is formed in accordance with the present invention. For instance, in one aspect, a two-ply tissue product can be formed. The first and second ply, for example, can be a multilayered tissue web formed according to the present invention. The configuration of the plies can also vary. For instance, in one aspect, one ply can be positioned such that a layer containing thermoplastic complex treated fibers can define a first outer surface of the tissue product to provide a soft feel with minimized slough to consumers. If desired, the other ply can also be positioned such that a layer containing treated fibers can define a second outer surface of the tissue product.

The plies may be similarly configured when more than two plies are utilized. For example, in some aspects, when forming a tissue product from three plies, fibrous webs comprising thermoplastic complex treated hardwood fibers can be positioned to define first and second outer surfaces of the tissue product to provide a soft feel with minimized slough to consumers. Additionally, a third fibrous web comprising untreated softwood fibers can be positioned to define an inner ply to provide enhanced strength of the tissue product to consumers. However, it should also be understood that any other ply configuration may be utilized in the present invention.

The present invention may be better understood with reference to the following examples.

### EXAMPLES

Preparation of Pulp Slurry

To prepare a pulp slurry, 24 grams (oven-dry basis) of ARACRUZ ECF were soaked in 2 liters of deionized water for 5 minutes. The pulp slurry was disintegrated for 5 minutes in a BRITISH PULP DISINTEGRATOR (commercially available from Lorentzen and Wettre AB, a business having offices located in Atlanta, Ga., U.S.A.). The slurry was then diluted with water to a volume of 8 liters. Desired amounts of chemical additives were then added to the slurry (described below). The slurry was mixed with a standard mechanical mixer at moderate shear for 5 minutes after addition of the chemical additives. A comparative example was also made without any chemical additives.

Preparation of Handsheets

Unless otherwise indicated, handsheets having a basis weight of 60 g/m² (gsm) were made using the following procedure. An appropriate amount of fiber required to make a 60 gsm sheet was measured into a graduated cylinder and diluted with water to form a fiber slurry. The slurry was then poured from the graduated cylinder into an 8.5-inch by 8.5-inch VALLEY handsheet mold, commercially available from Voith Inc., a business having offices located in Appleton, Wis., U.S.A., that had been pre-filled to the appropriate level with water. After pouring the slurry into the mold, the mold was then completely filled with water, including water used to rinse the graduated cylinder. The slurry was then agitated gently with a standard perforated mixing plate that was inserted into the slurry and moved up and down seven times, then removed. A valve was then opened to allow the water-fiber slurry to drain from the mold through a 90×90 mesh stainless-steel wire cloth with a 14×14 mesh backing wire located at the bottom of the mold to retain the fibers to form a fibrous web. The web was allowed to dewater using the vacuum formed by the water drop of 31.5 inches.

Two 360 gsm reliance grade blotter sheets (commercially available from Curtis Fine Papers, a business having offices located in Guardbridge, Scotland) were then placed on top of the web with the smooth side of the blotter sheet contacting the web. The web was then couched from the mold wire by using a 10 kg roller and passing over the sheets several times. The top blotter sheets were removed and the fibrous web was lifted with the lower blotter sheet to which it was attached. The lower blotter sheet was separated from the top blotter sheet, keeping the fibrous web attached to the lower blotter sheet. This blotter sheet was then positioned with the fibrous web facing up, and the blotter sheet was placed on top of two dry blotter sheets. Two additional dry blotter sheets were then placed on top of the fibrous web to make a total of five blotter sheets.

The stack of blotter sheets, including the fibrous web, was placed in a VALLEY hydraulic press (commercially available from Voith) and pressed for one minute at a pressure of 10 psi. The pressed web was then removed from the blotter sheets and placed on a VALLEY steam dryer (commercially available from Voith) with the wire-side surface of the web adjacent to the metal drying surface and a felt under tension on the opposite side of the web. Felt tension was provided by a 17.5 pound (8 kg) weight pulling downward on an end of the fabric that extends beyond the edge of the curved metal dryer surface. The fibrous web was then heated for 2 minutes with steam at a temperature of around 105 degrees Celsius and a pressure of 2.5 psig. The dried handsheet was trimmed to 7.5 inches square with a paper cutter and then weighed in a heated balance with the temperature maintained at 105° C. to obtain the oven dry weight of the web. Each handsheet was then tested for various properties.

Formation of the Thermoplastic Complex

Thermoplastic complexes were prepared by mixing an emulsified thermoplastic hydrophobic polymer with a cationic surfactant. Unless otherwise specified, LATRIX 6300 at a solids content of about 50% by weight was mixed with PROSOFT TQ-1003 at a solids content of about 80% weight by varying the mass ratio of each, and the properties of the complexes were observed. A LATRIX:PROSOFT ratio ranging from about 1:5 up to at least about 20:1 formed a whitish thermoplastic complex having a viscosity ranging from that of toothpaste to that of a milkshake. The actual ratios formed can be seen in the Tables below. It was observed that the viscosity of each thermoplastic complex was significantly higher than that of the individual components. Additionally, the resulting thermoplastic complex was readily re-dispersible in water and retentive onto pulp fibers.

### Example 1

In this example, handsheets containing fibers treated with the thermoplastic complex of the present invention were compared to handsheets having only an individual complex chemical component, or no complex chemical component at all. The thermoplastic complex was prepared having a mass ratio of 2 parts LATRIX 6300 and 1 part PROSOFT TQ-1003. A whitish thermoplastic complex of toothpaste viscosity resulted. The complex was then added to a pulp slurry in accordance with the procedure described above to form handsheets comprising treated fibers. A comparative example handsheet comprising no thermoplastic complex chemical components (Control 1), a comparative example handsheet containing PROSOFT TQ-1003 only (Control 2) and a comparative example handsheet containing LATRIX 6300 only (Control 3) were also prepared in accordance with the procedure above, for comparison. The handsheets were then tested for slough and tensile index. The results can be seen in Table 1.

TABLE 1
Eucalyptus Handsheets with wet-end additives

| | | | | Tensile | Delta |
|---|---|---|---|---|---|
| | | Dosage | Slough | Index | TI |
| Samples | Description | (kg/ODMT) | (mg) | (Nm/g) | (Nm/g) |
| Control 1 | No thermoplastic | — | 11.1 | 9.0 | — |
| | complex chemical | | | | |
| | components | | | | |
| Sample 1 | Thermoplastic | 10 | 10.4 | 4.5 | 4.5 |
| | Complex | | | | |
| | LATRIX/ | | | | |
| | PROSOFT | | | | |
| | (2/1) | | | | |
| Control 2 | PROSOFT only | 3.3 | 16.2 | 3.8 | 5.2 |
| Control 3 | LATRIX only | 6.7 | 13.2 | 10.8 | −1.8 |

* Note, samples that are identified as “Control #” represent comparative examples, while samples that are identified as “Sample #” represent examples of the invention.
** Delta TI = Tensile Index (control) − Tensile Index (sample)

It can be seen that the thermoplastic complex of the present invention significantly decreased the tensile index of the handhseets (which directly corresponds to an increase in softness) while it additionally slightly decreased the slough when compared to Control 1. In comparison, Control 2 decreased the tensile index but increased the slough when compared to Control 1, while Control 3 increased both the tensile index and the slough. Additionally, it can be seen that a synergetic debonding effect results from the thermoplastic complex as the decrease in tensile index (Delta TI=4.5) is higher than the sum of the debonding of the individual components (Delta TI=5.2-1.8=3.4).

### Example 2

In this example, handsheets containing fibers treated with the thermoplastic complex of the present invention were compared to handsheets where the individual complex chemical components were added sequentially (i.e., without first forming a complex), or without any complex chemical components at all. The thermoplastic complex was prepared having a mass ratio of 1 part PROSOFT TQ-1003 and 2 parts LATRIX 6300. A whitish thermoplastic complex of toothpaste viscosity resulted. The complex was then added to a pulp slurry in accordance with the procedure described above to form handsheets comprising treated fibers. A comparative example handsheet containing no thermoplastic complex chemical components (Control 1), a comparative example handsheet containing sequentially added LATRIX 6300 and PROSOFT TQ-1003 (Control 4), and a comparative example handsheet containing sequentially added PROSOFT TQ-1003 and LATRIX 6300 (Control 5) were also prepared in accordance with the procedure above, except that for the sequential addition of Control 4 and Control 5, the first component was mixed 2.5 minutes with the furnish before the second additive was added and subsequently mixed for another 2.5 minutes. The handsheets were then tested for slough and tensile index. The results can be seen in Table 2.

TABLE 2
Eucalyptus Handsheets with wet-end additives

| | | | Tensile |
|---|---|---|---|
| | | Slough | Index |
| Samples | Description | (mg) | (Nm/g) |
| Control 1 | No thermoplastic | 11.1 | 9.0 |
| | complex chemical | | |
| | components | | |
| Sample 2 | Thermoplastic Complex | 10.4 | 4.5 |
| | (3.3 Kg/T PROSOFT + 6.7 Kg/T | | |
| | LATRIX) | | |
| Control 4 | Sequential LATRIX (6.7 Kg/T) | 8.9 | 5.8 |
| | then PROSOFT | | |
| | (3.3 Kg/T) | | |
| Control 5 | Sequential PROSOFT | 8.4 | 5.0 |
| | (3.3 Kg/T) then LATRIX | | |
| | (6.7 Kg/T) | | |

*Note, samples that are identified as “Control #” represent comparative examples, while samples that are identified as “Sample #” represent examples of the invention.

It can be seen that handsheets made with the thermoplastic complex of the present invention resulted in a greater decrease of tensile index (i.e., a greater increase of softness) than those made with the sequential addition of the individual complex chemical components. This difference can be accentuated on a tissue machine as shear increases and additive retention decreases.

### Example 3

In this example, handsheets containing fibers treated with the thermoplastic complex of the present invention in varying concentrations were compared. The thermoplastic complex was prepared having a mass ratio of 1 part LATRIX 6300 and 1 part PROSOFT TQ-1003. A whitish thermoplastic complex of toothpaste viscosity resulted. The complex was then added to a pulp slurry in varying concentrations in accordance with the procedure described above to form handsheets comprising treated fibers. A comparative example handsheet containing no thermoplastic complex chemical components (Control 1) was also prepared. The handsheets were then tested for slough and tensile index. The results can be seen in Table 3.

TABLE 3
Effect of polymer complex concentration on handsheet properties.

| | | Dosage | Polymer/ | | Tensile |
|---|---|---|---|---|---|
| | | (kg/ | Surfactant | Slough | Index |
| Samples | | ODMT) | Ratio | (mg) | (Nm/g) |
| Control 1 | No thermoplastic | — | | 11.1 | 9.0 |
| | complex chemical | | | | |
| | components | | | | |
| Sample 3 | Thermoplastic | 1 | 1/1 | 11.0 | 10.2 |
| | Complex | | | | |
| | (LATRIX/ | | | | |
| | PROSOFT) | | | | |
| Sample 4 | Thermoplastic | 5 | 1/1 | 9.3 | 5.6 |
| | Complex | | | | |
| | (LATRIX/ | | | | |
| | PROSOFT) | | | | |
| Sample 5 | Thermoplastic | 9 | 1/1 | 11.7 | 4.5 |
| | Complex | | | | |
| | (LATRIX/ | | | | |
| | PROSOFT) | | | | |

* Note, samples that are identified as “Control #” represent comparative examples, while samples that are identified as “Sample #” represent examples of the invention.

It can be seen that the handsheet tensile index decreased (i.e., softness increased) as the thermoplastic complex concentration increased. In addition, slough similar to Control 1 was achieved over a large thermoplastic complex concentration range.

### Example 4

In this example, handsheets containing fibers treated with the thermoplastic complex of the present invention in varying concentrations were compared. The thermoplastic complexes were also prepared having varying mass ratios of LATRIX 6300 and PROSOFT TQ-1003. In all cases a whitish thermoplastic complex with viscosities ranging from that of toothpaste to that of a milkshake resulted. Each complex was then added to a pulp slurry in varying concentrations in accordance with the procedure described above to form handsheets comprising treated fibers. A comparative example handsheet containing no thermoplastic complex chemical components (Control 1) was also prepared. The handsheets were then tested for slough and tensile index. The results can be seen in Table 4.

TABLE 4
Effect of Polymer complex ratio and concentration on handsheet
properties.

| | | | Poly- | | |
|---|---|---|---|---|---|
| | | | mer/ | | |
| | | Dosage | Surfac- | | Tensile |
| | | (kg/ | tant | Slough | Index |
| Samples | Description | ODMT) | Ratio | (mg) | (Nm/g) |
| Control 1 | No thermoplastic | — | — | 13.8 | 9.5 |
| | complex chemical | | | | |
| | components | | | | |
| Sample 6 | Thermoplastic | 2.5 | 1/10 | 13.4 | 5.9 |
| | Complex | | | | |
| | (LATRIX/PROSOFT | | | | |
| Sample 7 | Thermoplastic | 2.5 | 10/1 | 10.6 | 10.2 |
| | Complex | | | | |
| | (LATRIX/PROSOFT | | | | |
| Sample 8 | Thermoplastic | 5 | 15/1 | 10.9 | 13.7 |
| | Complex | | | | |
| | (LATRIX/PROSOFT) | | | | |
| Sample 9 | Thermoplastic | 5 | 1/1 | 9.3 | 5.6 |
| | Complex | | | | |
| | (LATRIX/PROSOFT) | | | | |
| Sample 10 | Thermoplastic | 5 | 1/15 | 11.0 | 4.6 |
| | Complex | | | | |
| | (LATRIX/PROSOFT) | | | | |
| Sample 11 | Thermoplastic | 7.5 | 1/10 | 16.3 | 3.1 |
| | Complex | | | | |
| | (LATRIX/PROSOFT) | | | | |
| Sample 12 | Thermoplastic | 7.5 | 10/1 | 10.8 | 10.4 |
| | Complex | | | | |
| | (LATRIX/PROSOFT) | | | | |

* Note, samples that are identified as “Control #” represent comparative examples, while samples that are identified as “Sample #” represent examples of the invention.

It can be seen that there is an optimum in thermoplastic complex composition and concentration yielding optimal decreases in handsheet tensile index (i.e., optimal increases in softness) and optimal slough resistance. At a given thermoplastic complex concentration, handsheet slough and tensile are non-linear functions of the polymer complex composition ration (see Samples 8, 9 and 10). Handsheets having many combinations of tensile index and slough can be achieved by varying the composition and concentration of thermoplastic complex

### Example 5

In these examples, tissue webs having a basis weight of 30±2 gsm were formed on a through-air-dryer machine having a 3-layer headbox. The fiber split to the headbox was 33% by weight Eucalyptus fibers (outer layer)/34% by weight softwood fibers (inner layer)/33% by weight Eucalyptus fibers (outer layer). The Eucalyptus fiber was ARACRUZ ECF, and the softwood fiber was TERRACE BAY LONGLAC-19, a northern softwood Kraft pulp. For some samples, a thermoplastic complex (having a mass ratio of 2 parts LATRIX 6300 having a solids content of about 50% by weight and 1 part PROSOFT TQ-1003 having a solids content of about 80% by weight) was dispersed into the Eucalyptus fiber stream in the wet-end section of the tissuemaking process to be utilized for both outer layers. Also, for some samples, PAREZ NC 631, a strength agent, was added to the fiber used in the inner layer. Very soft tissues resulted when using the thermoplastic complex of the present invention in the tissue outer layers. The tissues were tested for slough, caliper and geometric mean tensile (GMT) properties. The results are presented in Table 5.

TABLE 5
Effect of Hydrophobic polymer complex on tissue properties.

| | | Parez in | | | |
|---|---|---|---|---|---|
| | | inner layer | | | |
| | Additive in | (kg/ | GMT | Slough | Caliper |
| Samples | outer layers | ODMT) | (g/3″) | (mg) | (micron) |
| Control 6 | No thermoplastic | 0 | 956 | 5.1 | 349 |
| | complex | | | | |
| Control 7 | No thermoplastic | 2 | 1092 | 4.7 | 362 |
| | complex | | | | |
| Control 8 | No thermoplastic | 5 | 1263 | 4.9 | 365 |
| | complex | | | | |
| Sample | 5 Kg/T | 0 | 676 | 6.2 | 378 |
| 13 | LATRIX:PROSOFT | | | | |
| | Complex | | | | |
| Sample | 5 Kg/T | 2 | 773 | 6.4 | 367 |
| 14 | LATRIX:PROSOFT | | | | |
| | Complex | | | | |
| Sample | 5 Kg/T | 5 | 920 | 5.5 | 375 |
| 15 | LATRIX:PROSOFT | | | | |
| | Complex | | | | |

* Note, samples that are identified as “Control #” represent comparative examples, while samples that are identified as “Sample #” represent examples of the invention.

It can be seen that the addition of the thermoplastic complex to the fibers located in the tissue's outer layers significantly decreased the geometric mean tensile (i.e., increased the softness) of the tissue. At the same time, even with the decreases in tensile, the level of slough was minimized. Additionally, the presence of the thermoplastic complex in the tissue's outer layers increased tissue caliper (which can result in a corresponding increase in bulk).

### Example 6

In these examples, an emulsified hydrophobic thermoplastic polymer was mixed with either a cationic surfactant or a cationic polyelectrolyte to form a thermoplastic complex of the present invention. To form the thermoplastic complexes, LATRIX 6300 at a solids content of about 50% by weight was mixed with either PROSOFT TQ-1003 at a solids content of about 80% by weight, KYMENE 6500 (a polyamine-polyamide epichlorohydrin having a solid content of around 12.5% by weight), or PAREZ 631 NC (a glyoxylated polyacrylamide having a solids content of around 6% by weight). The thermoplastic complexes were made by varying the mass ratio of LATRIX with the complexing agents.

The results were whitish thermoplastic complexes having viscosities ranging from that of toothpaste to that of a milkshake. The actual ratios formed can be seen below. It was observed that the viscosities of the thermoplastic complexes were significantly higher than that of the individual components. Additionally, the resulting thermoplastic complexes were readily re-dispersible in water and retentive onto pulp fibers.

Each complex was then added to a pulp slurry in accordance with the procedure described above to form handsheets comprising treated fibers. A comparative example handsheet containing no thermoplastic complex chemical components (Control 1), a comparative example handsheet containing LATRIX 6300 only (Control 9), a comparative example handsheet containing PAREZ 631 NC only (Control 10), and a comparative example handsheet containing KYMENE 6500 only (Control 11) were also prepared in accordance with the handsheet procedure above, for comparison. The handsheets were then tested for slough, tensile index, and wet tensile index. The results can be seen in Table 6.

TABLE 6
Polymer complexes with a cationic polyelectrolyte as complexing
agent

| | | | | Tensile | |
|---|---|---|---|---|---|
| | | Dosage | Slough | Index | Wet TI |
| Samples | Description | (Kg/T) | (mg) | (Nm/g) | (Nm/g) |
| Control 1 | No thermoplastic | — | 13.8 | 9.5 | — |
| | complex chemical | | | | |
| | components | | | | |
| Sample | Polymer Complex | 10 | 10.4 | 4.5 | — |
| 16 | LATRIX/PROSOFT | | | | |
| | (2/1) | | | | |
| Sample | Polymer Complex | 10 | 8.3 | 9.8 | 0.8 |
| 17 | LATRIX/PAREZ | | | | |
| | (2/1) | | | | |
| Sample | Polymer Complex | 10 | 8.0 | 10.4 | 1.3 |
| 18 | LATRIX/KYMENE | | | | |
| | (2/1) | | | | |
| Control 9 | LATRIX | 6.7 | 13.2 | 10.8 | — |
| Control | PAREZ | 3.3 | 7.0 | 13.3 | 1.9 |
| 10 | | | | | |
| Control | KYMENE | 3.3 | 9.6 | 10.4 | 3.1 |
| 11 | | | | | |

* Note, samples that are identified as “Control #” represent comparative examples, while samples that are identified as “Sample #” represent examples of the invention.

It can be seen that handsheets having the thermoplastic complex made with the cationic polyelectrolyte, such as Samples 17 and 18, have a lower slough and similar tensile index to that of Control 1. Handsheets having the thermoplastic complex made with the cationic polyelectrolyte exhibit improved properties compared to those made with the cationic polyelectrolyte only.

It can also be seen that handsheet properties may be affected by the type of complexation agent utilized. For example, handsheets made with a cationic surfactant may exhibit a higher slough and a lower tensile index than those made with a cationic polyelectrolyte.

Test Procedures

Tensile Test

Unless otherwise specified, all tensile strengths were measured according to TAPPI Test Method T 494 om-88 for tissue, modified in that a tensile tester was used having a 3-inch jaw width, a jaw span of 4 inches, and a crosshead speed of 10 inches per minute.

Dry MD and CD tensile strengths were determined using a MTS/SINTECH tensile tester (available from the MTS Systems Corp., a business having offices located in Eden Prairie, Minn., U.S.A.). Tissue samples measuring 3 inches wide were cut in both the machine and cross-machine directions. For each test, a sample strip was placed in the jaws of the tester, set at a 4-inch gauge length for facial tissue and 2-inch gauge length for bath tissue. The crosshead speed during the test was 10 inches/minute. The tester was connected to a computer loaded with data acquisition system software (e.g., MTS TESTWORK for WINDOWS). Readings were taken directly from a computer screen readout at the point of rupture to obtain the tensile strength of an individual sample. The sample was conditioned under TAPPI conditions (50% relative humidity and 22.7 degrees Celsius) before testing. Generally, 5 samples were combined for wet tensile testing to ensure that the load cell reading was in an accurate range.

Wet Tensile strength was measured in the same manner as dry tensile strength except that the tissue sample was folded without creasing about the midline of the sample, held at the ends, and dipped in deionized water for about 0.5 seconds to a depth of about 0.5 cm to wet the central portion of the sample, whereupon the wetted region was touched for about 1 second against an absorbent towel to remove excess drops of fluid, and the sample was unfolded and set into the tensile tester jaws and immediately tested.

The Tensile Index (TI) is a measure of tensile strength normalized for basis weight of the web tested in both dry and wet states. The tensile strength as measured above may be converted to tensile index using the following formula:
Tensile Index=Peak Load (N)/[Sample basis weight (g/m²)×Sample width (m)]
where peak load is expressed in Newtons (N), the sample basis weight is expressed in grams per square meter (g/m²), the sample width is expressed in meters (m), and the tensile index is expressed in Newton meter per gram (Nm/g).

The Geometric Mean Tensile (GMT) was also calculated for the samples to provide an average strength independent of test direction. The GMT was calculated using the following formula.
GMT=Square Root (MD tensile value×CD tensile value)
Caliper Test

The term “caliper” as used herein refers to the thickness of a single tissue sheet. Caliper may either be measured as the thickness of a single tissue sheet or as the thickness of a stack of ten tissue sheets where each sheet within the stack is placed with the same side up and dividing the measurement by ten. Caliper is expressed in microns or 0.001 inches. Caliper was measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” optionally with Note 3 for stacked tissue sheets. The micrometer used for carrying out T411 om-89 was a MODEL 49-72-00 BULK MICROMETER (available from TMI Company, a business having offices located in Amityville, N.Y. U.S.A.) or equivalent having an anvil diameter of 4 1/16 inches (103.2 millimeters) and an anvil pressure of 220 grams/square inch (3.3 kiloPascal).

Slough Test

In order to determine the abrasion resistance or tendency of the fibers to be rubbed from the web when handled (i.e., slough), each sample was measured by abrading the tissue specimens via the following method. This test measures the resistance of tissue material to abrasive action when the material is subjected to a horizontally reciprocating surface abrader. All samples were conditioned at 23° C. +/−1° C. and 50%+/−2% relative humidity for a minimum of 4 hours.

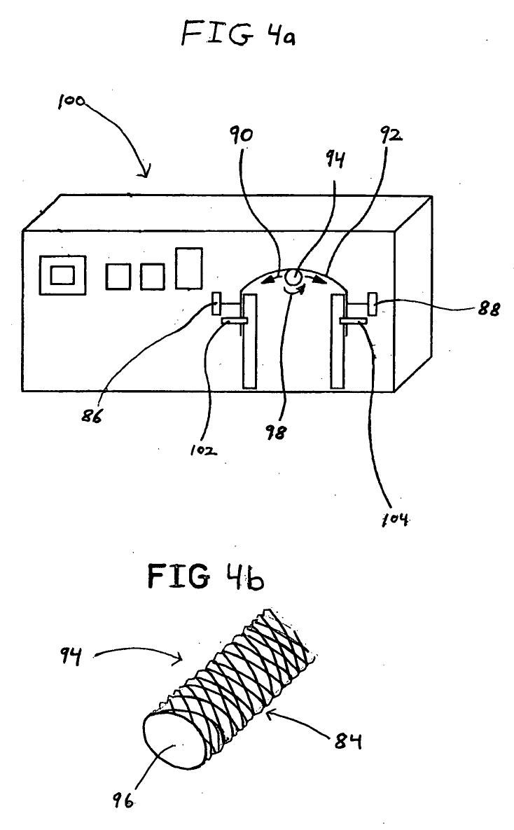

With reference to FIG. 4, the abrading spindle 94 contained a stainless steel rod 96, 0.5 inches in diameter with the abrasive portion 84 having a 0.005 inches deep diamond pattern extending 4.25 inches in length around the entire circumference of the rod 96. The spindle 94 was mounted perpendicularly to the face of the instrument such that the abrasive portion 84 of the rod 96 extends out its entire distance from the face of the instrument 100. Guide pins 102, 104 with magnetic clamps 86,88 are located on each side of the spindle 94, one movable 86 and one fixed 88, spaced 4 inches apart and centered about the spindle 94. The movable clamp 86 and guide pins 102 were allowed to slide freely in the vertical direction, providing the means for insuring a constant tension of the sample over the spindle 94 surface.

Using a die press with a die cutter, the specimens 92 were cut into 3+/−0.05 inch wide by 8 inch long strips with two holes (not shown) at each end of the sample 92 for the guide pins 102, 104 to fit through. For the tissue samples 92, the MD direction corresponds to the longer dimension. Each test strip 92 was then weighed to the nearest 0.1 mg. Each end of the sample 92 was slid onto the guide pins 86,88 and magnetic clamps 86,88 held the sheet 92 in place. The movable jaw 86 was then allowed to fall providing constant tension across the spindle 94.

The spindle 94 was then moved back and forth at an approximate 15 degree angle from the centered vertical centerline in a reciprocal horizontal motion 90 against the test strip 92 for 40 cycles (each cycle is a back and forth stroke), at a speed of 80 cycles per minute, removing loose fibers from the web surface. Additionally, the spindle 94 rotated counter clockwise 98 (when looking at the front of the instrument) at an approximate speed of 5 RPMs. The magnetic clamps 86,88 were then removed from the sample 92 and the sample 92 was slid off of the guide pins 102, 104 and any loose fibers on the sample 92 surface were removed by blowing compressed air (approximately 5-10 psi) on the test sample 92. The test sample 92 was then weighed to the nearest 0.1 mg and the weight loss was calculated. Ten test samples per tissue sample were tested and the average weight loss value in milligrams was recorded.

It will be appreciated that details of the foregoing examples, given for purposes of illustration, are not to be construed as limiting the scope of this invention. Although only a few exemplary embodiments of this invention have been described in detail above, those skilled in the art will readily appreciate that many modifications are possible in the examples without materially departing from the novel teachings and advantages of this invention. For example, features described in relation to one example may be incorporated into any other example of the invention.

Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention. As various changes could be made in the above constructions without departing from the scope of the invention, it is intended that all matter contained in the above description shall be interpreted as illustrative and not in a limiting sense.

What is claimed is:

1. A tissue product comprising at least one fibrous web which comprises cellulosic fibers treated with a thermoplastic complex; wherein said thermoplastic complex comprises an emulsified hydrophobic thermoplastic polymer and a complexing agent.

2. The tissue product of claim 1 wherein said thermoplastic complex is present in an amount between 1 and 100 kilograms per oven-dry metric ton of said cellulosic fibers.

3. The tissue product of claim 1 wherein said complexing agent is a cationic surfactant.

4. The tissue product of claim 1 wherein said complexing agent is a cationic polyelectrolyte.

5. The tissue product of claim 1 wherein said emulsified hydrophobic thermoplastic polymer is selected from the group consisting of polyolefin and copolymers thereof, styrene butadiene latex and copolymers thereof, polyvinyl acetate copolymers, vinyl acetate acrylic copolymers, ethylene-vinyl chloride copolymers, acrylic polymers, nitrile polymers, and combinations thereof.

6. The tissue product of claim 1 wherein said emulsified hydrophobic thermoplastic polymer has a glass transition temperature of less than 40° C.

7. The tissue product of claim 1 wherein said emulsified hydrophobic thermoplastic polymer is nonionic.

8. The tissue product of claim 1 wherein said emulsified hydrophobic thermoplastic polymer has a solids content between about 40% and about 80% by weight.

9. The tissue product of claim 1 wherein said thermoplastic complex is dispersible in a water-fiber suspension.

10. The tissue product of claim 1 wherein said thermoplastic complex substantially retains onto said cellulosic fibers during a tissuemaking process.

11. The tissue product of claim 1 wherein said cellulosic fibers treated with said thermoplastic complex are distributed uniformly throughout said at least one fibrous web.

12. The tissue product of claim 1 wherein said at least one fibrous web comprises substantially hardwood fibers.

13. The tissue product of claim 12 wherein said hardwood fibers comprise Eucalyptus fibers.

14. The tissue product of claim 1 wherein said at least one fibrous web is a multilayered fibrous web having two outer layers; wherein at least one of said outer layers comprises cellulosic fibers treated with said thermoplastic complex.

15. The tissue product of claim 1 wherein said at least one fibrous web is creped.

16. The tissue product of claim 1 wherein said at least one fibrous web is molded and through-air dried.

17. The tissue product of claim 1 wherein said at least one fibrous web has a basis weight in the range of about 20 gsm to about 100 gsm.

18. A tissue product made by the process comprising:
mixing an emulsified hydrophobic thermoplastic polymer with a complexing agent to form a thermoplastic complex;
dispersing said thermoplastic complex into a fiber slurry comprising water and cellulosic fibers to form treated fibers;
forming a fibrous web comprising said treated fibers; and
converting said fibrous web into said tissue product.

19. The tissue product of claim 18 wherein said thermoplastic complex consists essentially of said emulsified hydrophobic thermoplastic polymer and said complexing agent.

20. The tissue product of claim 18 wherein said complexing agent is a cationic surfactant.

21. The tissue product of claim 18 wherein said complexing agent is a cationic polyelectrolyte.

22. The tissue product of claim 18 wherein said emulsified hydrophobic thermoplastic polymer is selected from the group consisting of polyolefin and copolymers thereof, styrene butadiene latex and copolymers thereof, polyvinyl acetate copolymers, vinyl acetate acrylic copolymers, ethylene-vinyl chloride copolymers, acrylic polymers, nitrile polymers, and combinations thereof.
